(19) United States
(12) Patent Application Publication
(10) Pub. No.: US 2014/0114740 A1
(43) Pub. Date: Apr. 24, 2014

(54) Method of increasing effectiveness of advertisements

(71) Applicant: Pratik Singh, Ghaziabad (IN)

(72) Inventor: Pratik Singh, Ghaziabad (IN)

(73) Assignee: Pratik Singh, Ghaziabad (IN)

(21) Appl. No.: 13/656,666

(22) Filed: Oct. 20, 2012

(51) Int. Cl. G06Q 30/02

(52) U.S. Cl. CPC G06Q 30/0242
USPC 705/14.41

(57) ABSTRACT

The purpose of this invention is to increase the effectiveness of advertisements. To realize this, advertisements are made more trustworthy through certification. People today are bombarded with ever increasing advertisements on all kinds of media such as, but not limited to, internet; mobile; print; television; movies; games; radio; billboards; it is becoming increasingly difficult for people to decide which advertisement to believe more than the other.

Certified advertisements will indicate certain level of truthfulness in advertisements, helping people to decide which advertisements to believe and eventually respond to.

Certification of advertisement will be based on, but not limited to, the extent to which content of the advertisement can be reviewed and validated. Review of the advertisement content will include, but not limited to, verifying offers; claims; fine prints; missing prints; history of advertiser on delivering on promises; current and previous complaints against advertiser. Validation will include, but not limited to, validating the sources; references; statistics used.

Advertisement's certificate will indicate that the advertisement has been reviewed and validated by an independent agency.

### CROSS-REFERENCES TO RELATED APPLICATIONS

This application claims the benefit of U.S. Provisional Application No. 61/523,974 filed on Aug. 16, 2011. This specification is substitution of application Ser. No. 13/584,822 filed on Aug. 14, 2012.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

Aspects of the present invention relate generally to the advertisement process and, in particular, to a method of increasing effectiveness of advertisements.

2. Description of the Related Art

People today are bombarded with ever increasing advertisements on all kinds of media such as, but not limited to, internet; mobile; print; television; movies; games; radio; and billboards. It is becoming increasingly difficult for people to trust advertisements, sometime, due to their limited ability to verify statements/claims made in the advertisements, specially in cases where advertisements are from competing advertisers.

Currently advertisement content do get reviewed by, one or more parties involved in the advertisement process such as, but not limited to, advertising agency; advertising agent; and advertiser. Advertisers sometime, either through in-house; consultants; or consulting firms, get advertisement content reviewed, so as to make sure that advertisement complies with laws, and/or comply with guidelines issued by organizations such as, but not limited to, industry specific organizations; consumer organizations; rating agencies; and advertisement associations. Though, advertisements currently do get reviewed and verified by one or more parties involved directly or indirectly with the advertisement process, current advertisement review process, most of time, aim to fulfill legal requirements and guidelines. Adhering to legal requirements and guidelines may not be enough in many cases, this is the reason consumer/public complaints; complaints from advertiser's competitors, against advertisements are not uncommon. Advertisers, intentionally or unintentionally, may not have cared for the best interest of public, and may have released advertisements containing: ambiguous language; ambiguous claims; confusing fine prints; unreasonable conditions; ethical issues; etc. Moreover, there are limited channels through which people can give feedback: they can either write to advertiser, in which case they are totally at the mercy of advertiser, or take legal course of action. In case of complaints, if advertiser, voluntarily or non-voluntarily, decides to takes necessary corrective actions such as, but not limited to, correcting advertisement; stopping advertisements; pay compensation; pay fines, the process is expensive and time-consuming.

Therefore, there is a need for improvement in current process of advertisement, through which advertisements can be made more effective by increasing level of trust and belief among audiences of the advertisements though independent review and certification, and provide a more effective channel, to the audiences of advertisements, for sending their feedback/comments/complaints.

### BRIEF SUMMARY OF THE INVENTION

It is an object of an exemplary embodiment of the present invention to provide a method of increasing effectiveness of advertisement through certification. The embodiment adds an additional step of certification, by an independent certifying agency, in the advertisement process.

Certification of advertisement will be based on, but not limited to, the extent to which content of the advertisement can be reviewed and validated. Review of the advertisement content will include, but not limited to, verifying offers; claims; fine prints; missing prints; history of advertiser on delivering on promises; current and previous complaints against advertiser. Validation will include, but not limited to, validating the sources; references; statistics used in the advertisement.

Certifying agency is responsible for certifying the advertisement, and to make sure that advertisement's certificate remains valid in light on new fact(s) and/or consumer/public comments/feedback.

### BRIEF DESCRIPTION OF THE SEVERAL VIEWS OF THE DRAWINGS

The invention is pointed out with particularity in the appended claims. However, other features of the invention will become more apparent and the invention will be best understood by referring to the following detailed description in conjunction with the accompanying drawings in which:

FIG. 1 is a schematic representation of a typical advertisement process without any embodiment of the present invention;

FIG. 2 is a schematic representation of a modified advertisement process with a preferred embodiment of the present invention;

FIG. 3 shows a flowchart for a method of advertisement certification process, in accordance with a preferred embodiment of the present invention;

FIG. 4 shows a flowchart for a method of advertisement correction process, in accordance with a preferred embodiment of the present invention;

FIG. 5 shows a flowchart for a method of advertisement certification process for different certification levels, in accordance with a preferred embodiment of the present invention;

FIG. 6 shows a flowchart for a method of advertisement certification process for displaying the certificate, in accordance with a preferred embodiment of the present invention;

FIG. 7 illustrates method by which advertisement certificate/certification details can be made accessible, in accordance with a preferred embodiment of the present invention;

FIG. 8 illustrates method by which audiences can send comments or file complaints, in accordance with a preferred embodiment of the present invention;

FIG. 9 shows a flowchart for a method of advertisement certification process wherein advertisement is certified with an expiry datetime, in accordance with a preferred embodiment of the present invention;

In describing the preferred embodiment of the invention which is illustrated in the drawings, specific terminology will be resorted to for the sake of clarity. However, it is not intended that the invention be limited to the specific term so selected and it is to be understood that each specific term includes all technical/non-technical equivalents which operate in a similar manner to accomplish a similar purpose. For example, the word ‘consumer’ or term similar thereto are often used to refer to the audiences of advertisement. They are not limited to ‘consumer’, but include meaning of other similar terms as, but not limited to, client; customer; potential customer; etc.

### DETAILED DESCRIPTION OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements.

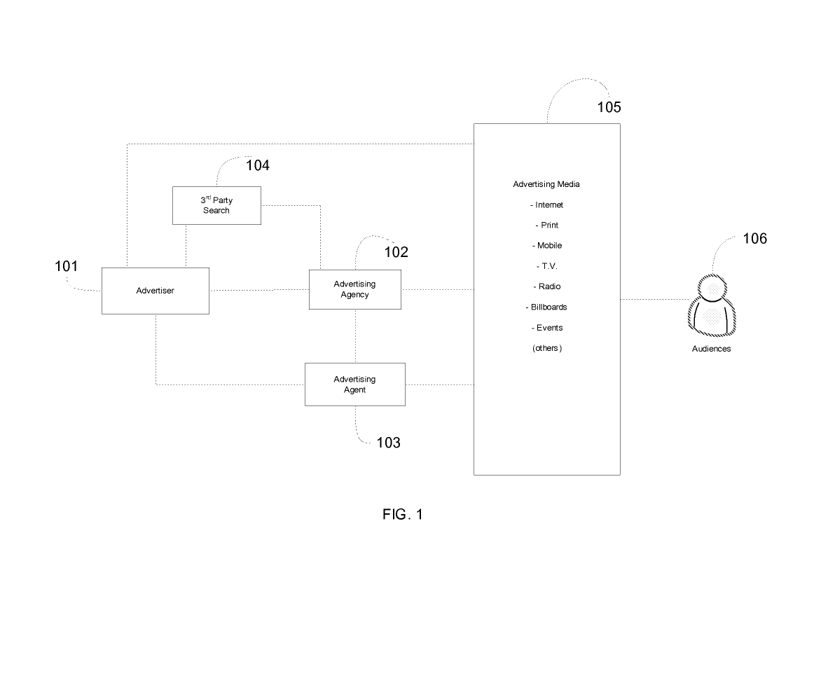

FIG. 1 is a schematic representation of different entities involved in a typical advertisement process. Advertiser 101 is the entity intending to advertise. Advertising Agency 102 is responsible for creating advertisement. Advertisement Agent 103 is responsible for placing advertisement on Advertising Media 105. 3^{rd} Party Search 104 is responsible for providing statistics; surveys; data needed for creating content of advertisement. Advertising Media 105 is one or more combination of media that can be used to place advertisement. Audiences 106 are audiences of advertisement. There are multiple ways in which one or more entities: 101, 102, 103, 104, 105, and 106 can interact as part of advertisement process. One of a simple process could be: Advertiser 101 creating its own advertisement without any help from Advertising Agency 102, Advertising Agent 103 or 3^{rd} Party Search 104, and directly placing the advertisement on Advertising Media 105. In another scenario, Advertiser 101 takes help of Advertising Agency 102 in creating advertisement and then places advertisement directly on Advertising Media 105. As shown by previous two examples, there are multiple ways in which entities 101, 102, 103, 104, 105 & 106 can interact. Claims of this invention is no way limited to the ways or combinations in which different entities in FIG. 1 can interact in order to create and/or display advertisements.

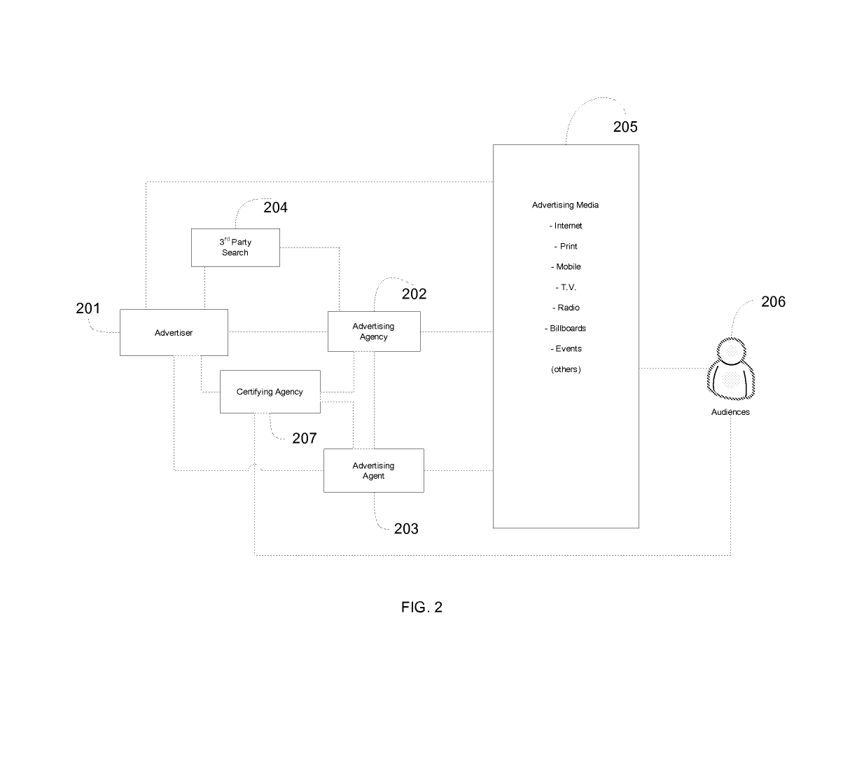

FIG. 2 is a schematic representation of the advertisement process illustrating the general architecture of preferred embodiment of the invention, wherein Certifying Agency 207 has been added to a typical advertisement process. Advertiser 201 is the entity intending to advertise. Advertising Agency 202 is responsible for creating advertisement. Advertisement Agent 203 is responsible for placing advertisement on Advertising Media 205. 3^{rd} Party Search 204 is responsible for providing statistics; surveys; data needed for creating content of advertisement. Advertising Media 205 is one or more combination of media that can be used to place advertisement. Audiences 206 are audiences of advertisement. Certifying Agency 207 is the entity responsible for certifying advertisement. There are multiple ways in which one or more entities 201, 202, 203, 204, 205, 206, and 207 can interact as part of advertisement process. One of a simple process could be: Advertiser 201 creating advertisement without any outside help and just getting the advertisement certified by Certifying Agency 207. In another scenario, Advertiser 201 outsources advertisement campaign to Advertising Agency 202. Advertising Agency 202 then works on behalf of Advertiser 201. Advertising Agency 202 is now responsible for creating advertisement campaign and involves Certifying Agency 207 to get the advertisement certified. Also shown in FIG. 2 is an feature of the invention wherein Audiences 206 can contact Certifying Agency 207 to get more details of advertisement and to give feedback and/or send complains regarding advertisement.

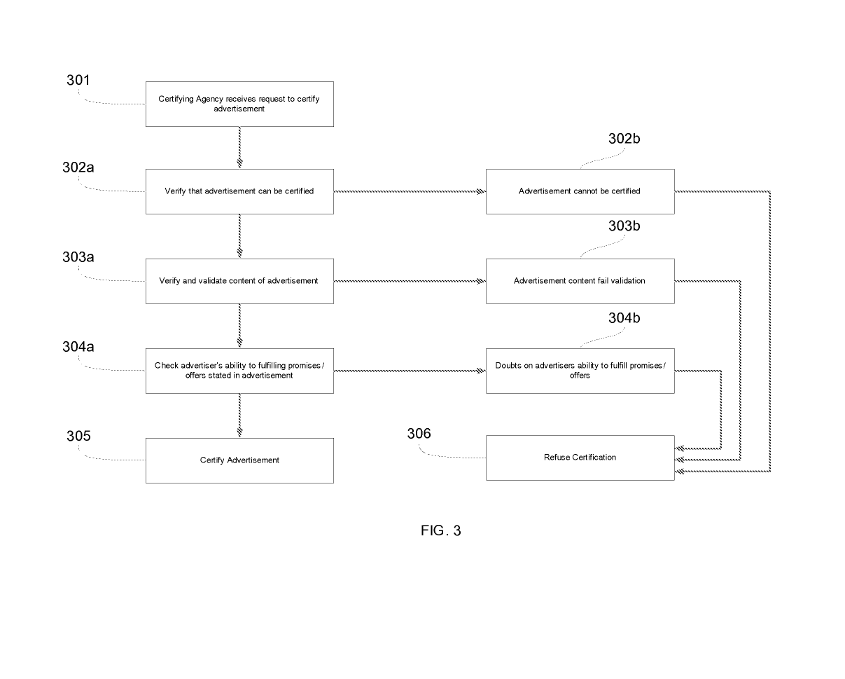

FIG. 3 shows a flowchart for a method of advertisement certification process, that may be used by certifying agency, in accordance with a preferred embodiment of the present invention. At step 301, certifying agency receives request to certify advertisement. Certification request can be made by any entity, part of advertisement process such as, but not limited to, Advertiser; Advertising agency; Advertising agent; and Advertising Media. At step 302a, certifying agency verifies that advertisement can be certified. As part of step 302a, certifying agency perform action such as, but not limited to, verify that there is no conflict of interest and certifying agency can certify advertisement impartially; verify that the content of advertisement can be validated. If advertisement do not fulfill minimum requirements set by the certifying agency for step 302a, certifying agency initiates step 302b, else certifying agency initiates step 303a. At step 302b, certifying agency prepares detailed report on why advertisement cannot be certified, and initiates step 306. At step 303a, certifying agency validates the content of advertisement. If advertisement do not fulfill minimum requirements set by the certifying agency for step 303a, certifying agency initiates step 303b, else certifying agency initiates step 304a. At step 303b, certifying agency prepares detailed report on why advertisement cannot be certified, and initiates step 306. At step 304a, certification agency checks details such as, but not limited to, ability and willingness of advertiser; history of advertiser; current and previous complaints against advertiser. If advertisement do not fulfill minimum requirements set by the certifying agency for step 304a, certifying agency initiates step 304b, else certifying agency initiates step 305. At step 304b, certifying agency prepares detailed report on why advertisement cannot be certified, and initiates step 306. At step 305, certifying agency certifies the advertisement. At step 306, certifying agency sends detailed report, to the certification requester, on why certificate has been refused.

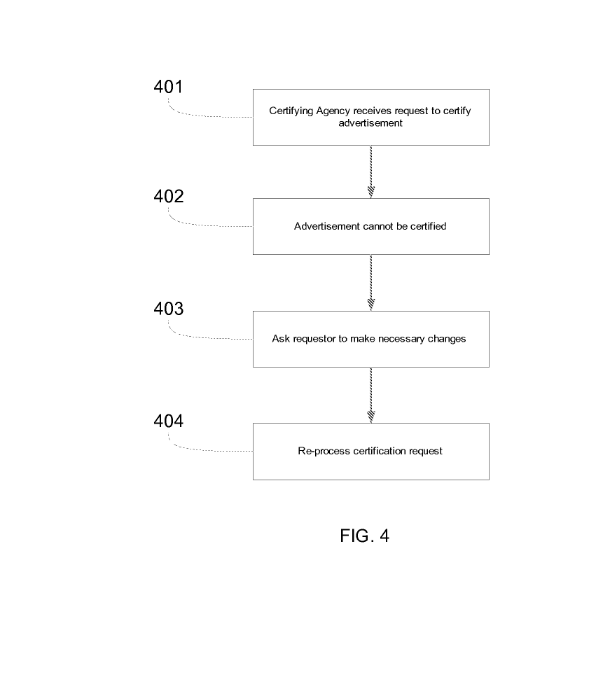

FIG. 4 shows a flowchart for a method of advertisement correction process, that may be used by certifying agency, in accordance with a preferred embodiment of the present invention. At step 401, certifying agency receives request to certify advertisement. Certification request can be made by any entity, part of advertisement process such as, but not limited to, Advertiser; Advertising agency; Advertising agent; and Advertising Media. At step 402, certifying agency comes to conclusion that advertisement cannot be certified. At step 403, certifying agency asks the certificate requester to make necessary changes to the advertisement that would qualify the advertisement for certification. At step 404, certifying agency initiates the certification process again based on the changed advertisement. It is possible that the certification requester refuse to make changes suggested by the certifying agency, in that case certifying agency will not reprocess the certification request and advertisement will not be certified.

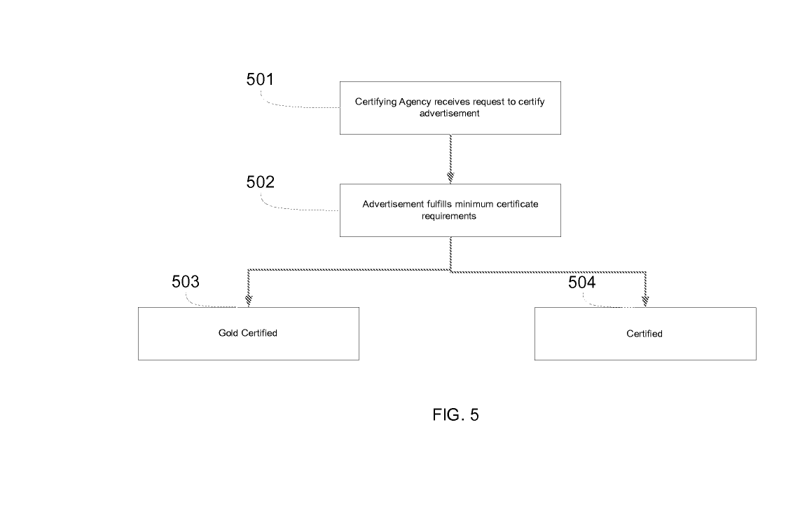

FIG. 5 shows a flowchart for a method of advertisement certification process for different certification levels, that may be used by certifying agency, in accordance with a preferred embodiment of the present invention. At step 501, certifying agency receives request to certify advertisement. Certification request can be made by any entity, part of advertisement process such as, but not limited to, Advertiser; Advertising agency; Advertising agent; and Advertising Media. At step 502, certifying agency comes to conclusion that advertisement can be certified, as advertisement fulfills minimum certification requirements. At step 503, certifying agency assigns gold certificate to the advertisement. At step 504, certifying agency assigns normal certificate to the advertisement. As shown in FIG. 5, certifying agency, may decide to implement different level of certification. Depending upon extent to which a advertisement conforms to the certification requirements beyond minimum certification requirements, certifying agency can assign different level of certifications. As shown in step 503, advertisement can be given gold certificate if advertisement conforms to highest possible certificate requirements, else certifying agency may decide to give normal certificate. Note that number of certification levels: Gold; Normal, used in FIG. 5, in no way should limit the scope of the disclosure.

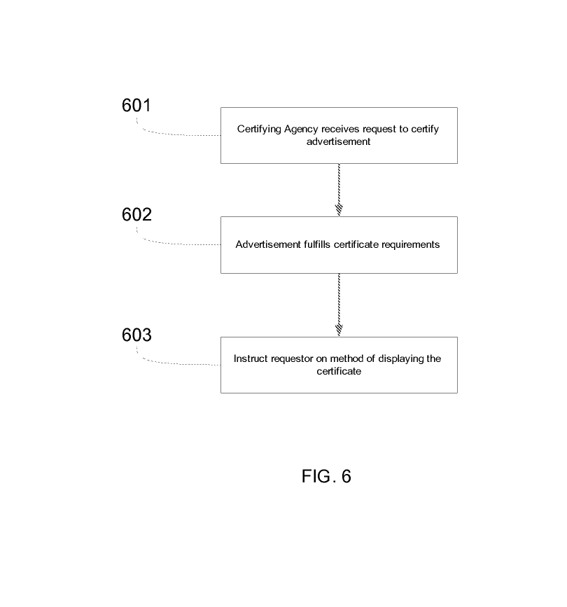

FIG. 6 shows a flowchart for a method of advertisement certification process for displaying the certificate, that may be used by certifying agency, in accordance with a preferred embodiment of the present invention. At step 601, certifying agency receives request to certify advertisement. Certification request can be made by any entity, part of advertisement process such as, but not limited to, Advertiser; Advertising agency; Advertising agent; and Advertising Media. At step 602, certifying agency comes to conclusion that advertisement can be certified, as advertisement fulfills certification requirements. At step 603, certifying agency gives instructions, to the certificate requester, on the method for displaying the certificate. Certificate can be displayed in multiple ways such as, but not limited to, audio; visual; textual; and/or any combination of audio, visual, and textual.

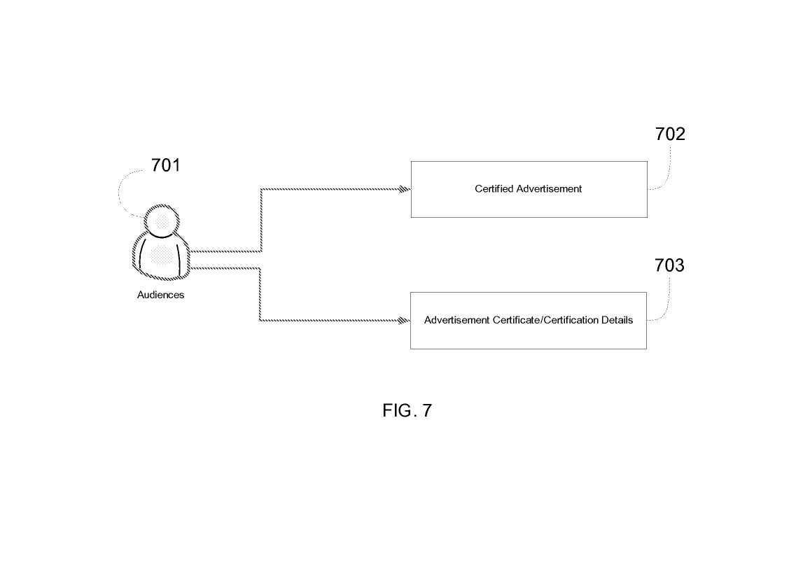

FIG. 7 illustrates method by which advertisement certificate/certification details can be made accessible, in accordance with a preferred embodiment of the present invention. Audiences 701 represents people watching a certified advertisement. Watching advertisement refers to any means such as, but not limited to, radio; television; internet; billboards; movie; video games; mobile; and print, by which a person can come across the advertisement. Certified advertisement 702 is the advertisement certified by a certifying agency. Advertisement certificate/certification details 703 is the document, accessible to the advertisement audiences, that contains details of the certificate; certification process; and the rationale behind certifying the advertisement. Advertisement certificate/certification details document 703 can be accessible to advertisement audiences through internet, or provision can be made whereby, on the certificate/certification details request, certificate/certification details 703 can be send to advertisement audiences 701 through means such as, but not limited to, email; fax; SMS; and snail mail. Certified advertisement will contain details of method that can be used to obtain certificate/certification details 703.

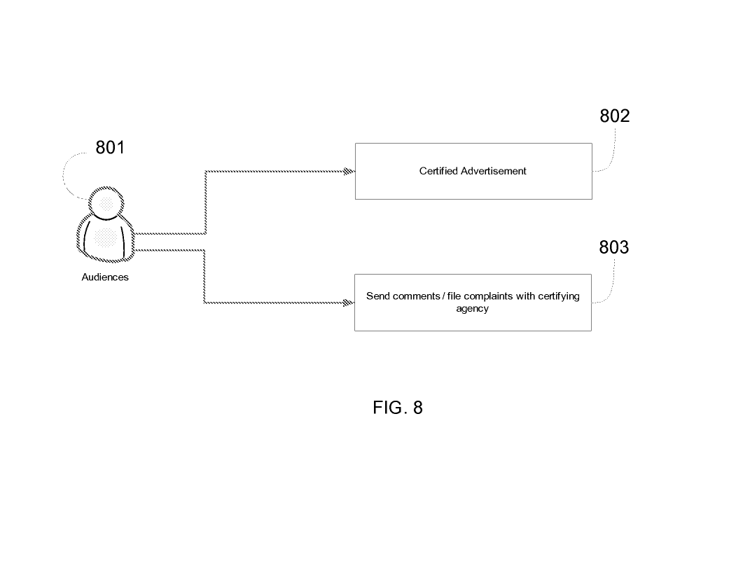

FIG. 8 illustrates method by which audiences can send comments or file complaints, in accordance with a preferred embodiment of the present invention. Audiences 801 represents people watching a certified advertisement. Watching advertisement refers to any means such as, but not limited to, radio; television; internet; billboards; movie; video games; mobile; and print, by which a person can come across the advertisement. Certified advertisement 802 is the advertisement certified by a certifying agency. Send comments/file complaints with certifying agency 803 is a process by which audiences can send comments or file complaints against advertiser/advertisement. Certified advertisement 802 will contain details of method that can be used to send comments or file complaints with certifying agency. Audiences 801 can follow the method mentioned in the certified advertisement to send comments or file complaints. Certifying agency can then take action based on audiences comments/complaints if necessary.

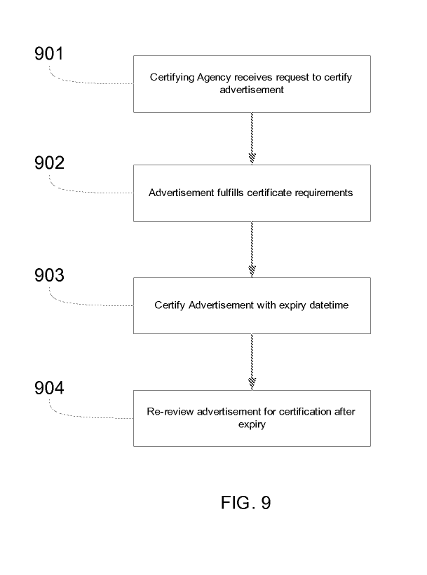

FIG. 9 shows a flowchart for a method of advertisement certification process wherein advertisement is certified with an expiry datetime, in accordance with a preferred embodiment of the present invention. At step 901, certifying agency receives request to certify advertisement. Certification request can be made by any entity, part of advertisement process such as, but not limited to, Advertiser; Advertising agency; Advertising agent; and Advertising Media. At step 902, certifying agency comes to conclusion that advertisement can be certified, as advertisement fulfills certification requirements. At step 903, certifying agency gives certification with an expiry datetime. At step 904, certifying agency initiates the certification process again after advertisement certificate expires. Depending on the contract between the certification requester and certifying agency, re-certification process can either be automatic i.e. certification agency initiates certification process again without any new request from the initial advertisement certificate requester, or advertising agency waits for a new request from the advertisement certificate requester before initiating certification process again.

Although the invention herein has been disclosed in the context of typical advertisement process shown in FIG. 1, it will be understood by those skilled in the art that the present invention extend beyond the specifically disclosed processes to other alternative advertisement processes. In addition, while a number of variations have been shown, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention.

What is claimed is:

1. Method of increasing effectiveness of advertisements through certification, said method comprising, one or more combinations of A. Validating content of advertisement and making sure that content of the advertisement do not contain any misleading information; B. Verifying and validating the information, and their sources, implied as facts/truth in the advertisement; C. Verifying and validating capability of advertiser to deliver on promises in the advertisement; D. Check history of advertiser on how advertiser behaved/acted during previous advertising campaign(s); E. Verify and validate advertiser's ability and willingness to act on audiences' grievances; F. Ensuring Advertisement has enough information and has necessary cautions; warnings; limitations; etc.

2. Method of claim 1, further comprising of certifying advertisements at one or more different levels depending upon, but not limited to, degree of validation and verification done. Examples of different level of certification could be Gold Certification; Silver certification; etc.

3. Method of claim 1, further comprising of indication that the advertisement has been certified. Certification can be indicated through, but not limited to, text; graphics; audio/visual messages.

4. Method of claim 1, further comprising of giving ability to audiences of the advertisement to get information on how and/or why the advertisement was certified.

5. Method of claim 1, further comprising of giving ability to audiences of the advertisement to send comments; suggestions; and complaints to certifying agency regarding certified advertisement.

6. Method of claim 1, further comprising of setting expiry date after which advertiser will have to get the advertisement re-certified.
